(19) United States
(12) Patent Application Publication
(10) Pub. No.: US 2008/0305810 A1
(43) Pub. Date: Dec. 11, 2008

(54) METHOD AND APPARATUS FOR PROVIDING A SERVICE USING LOCATION INFORMATION IN A MOBILE COMMUNICATION TERMINAL

(75) Inventor: Sung-Jun LEE, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/133,582

(22) Filed: Jun. 5, 2008

(30) Foreign Application Priority Data
Jun. 5, 2007 (KR) 2007-0054834

(51) Int. Cl. H04Q 7/20

(52) U.S. Cl. 455/456.5

(57) ABSTRACT

A method and apparatus for providing a service using location information in a mobile communication terminal are provided. The method includes identifying service area information and operation information allocated to each corresponding area information from a Subscriber Identification Mobile (SIM) card, transmitting operation information allocated to area information representing a current location of the terminal to a service provider server, and receiving a service corresponding to the operation information from the service provider server.

### PRIORITY

This application claims the benefit under 35 U.S.C. § 119(a) of a Korean patent application filed in the Korean Intellectual Property Office on Jun. 5, 2007 and assigned Serial No. 2007-0054834, the entire disclosure of which is hereby incorporated by reference.

### BACKGROUND OF THE INVENTION

1. Field of the Invention

The present invention relates to a method and apparatus for providing a service depending on a location of a mobile communication terminal. More particularly, the present inventions relates to a method and apparatus for providing a specific service to a user depending on a location of a mobile communication terminal, using location-based service information that is stored in a Subscriber Identification Mobile (SIM) card.

2. Description of the Related Art

Due to the convenience of portability, mobile communication terminals have become popular. Thus, mobile service providers are competitively providing more convenient services so as to secure more users.

In a conventional mobile communication system, most services are provided based on a unit cell. As shown in FIG. 1, the mobile communication system is providing, for example, a call charge discount service or a specific information broadcast service on the basis of each cell. In detail, the mobile communication system is providing a service of discounting communication charges of mobile communication terminals performing calls in a specific cell on the basis of a unit cell and allowing each Base Station (BS) to provide specific information to all users located within its own cell through broadcasting.

As aforementioned, the conventional mobile communication system is providing most services on the basis of a cell without taking into consideration exact locations of mobile communication terminals. However, currently, there is a need for a service of providing users of mobile communication terminals with specific information that is suitable to their exact locations.

For example, a specific resort is providing information such as a history or a feature of the resort to users through a document, a Radio Frequency IDentification (RFID) tag, etc. However, such a method of providing information on a corresponding location using a document or a RFID tag as aforementioned has an inconvenience of having to install a means for providing the information to users one by one at each location and has a problematic limit even in the type or amount of information that can be provided to the users.

### SUMMARY OF THE INVENTION

An aspect of the present invention is to address at least the above-mentioned problems and/or disadvantages and to provide at least the advantages below. Accordingly, one aspect of the present invention is to provide a method and apparatus for providing a service depending on a location of a mobile communication terminal.

Another aspect of the present invention is to provide a method and apparatus for providing a mobile communication terminal with a customized service depending on a location of the mobile communication terminal, using location-based service information that is stored in a Subscriber Identification Mobile (SIM) card.

The above aspects can be addressed by providing a method and apparatus for providing a service depending on a location of a mobile communication terminal.

According to one aspect of the present invention, a method for providing a service using location information in a mobile communication terminal is provided. The method includes identifying service area information and operation information allocated to each area information from a Subscriber Identification Mobile (SIM) card, transmitting operation information allocated to area information representing a current location of the terminal to a service provider server, and receiving a service corresponding to the operation information from the service provider server.

According to another aspect of the present invention, a method for providing a service using location information in a service provider server is provided. The method includes receiving operation information corresponding to a current location of a terminal from the terminal, and searching a service corresponding to the received operation information and providing the searched service to the terminal.

According to a further aspect of the present invention, a method for providing a service using location information on a mobile communication terminal. The method includes identifying service area information and operation information allocated to each area information from a Subscriber Identification Mobile (SIM) card, transmitting operation information allocated to area information representing its own current location, to a service provider server, and receiving a service corresponding to the operation information searched and provided by the service provider server.

According to still another aspect of the present invention, an apparatus for providing a service using location information in a mobile communication terminal is provided. The apparatus includes a Subscriber Identification Mobile (SIM) card for storing area information for provision of a service suitable to location and operation information of a service provided in each area, a SIM processor for identifying the area information and the operation information from the SIM card, and a controller for controlling to transmit operation information allocated to area information representing a current location of the terminal to a service provider server and processing a service received from the service provider server.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following description when taken in conjunction with the accompanying drawings in which:

FIG. 1 is a diagram illustrating a conventional system for providing a service;

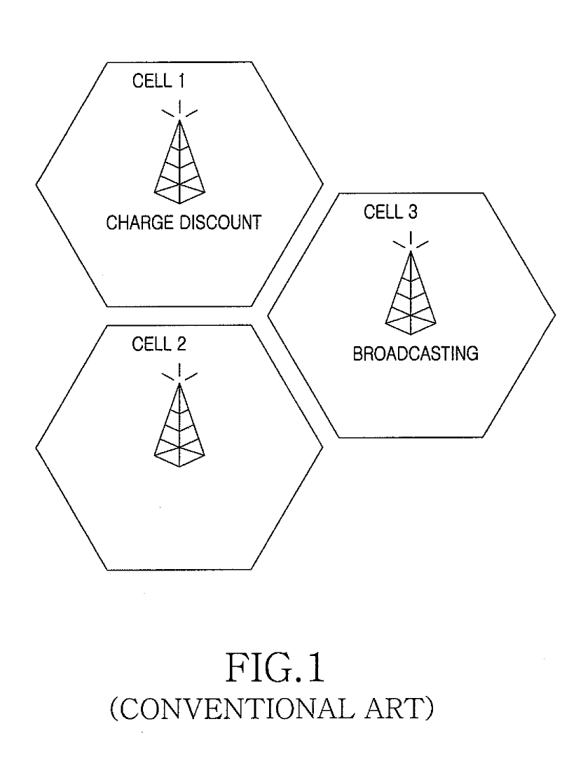

FIG. 2 is a schematic diagram illustrating a construction of a system for providing a customized service depending on a location of a mobile communication terminal according to an exemplary embodiment of the present invention;

FIG. 3 is a block diagram illustrating a construction of a mobile communication terminal according to an exemplary embodiment of the present invention;

FIG. 4 is a flowchart illustrating a process of a mobile communication terminal for providing a customized service depending on location according to an exemplary embodiment of the present invention;

FIG. 5 is a ladder diagram illustrating a signal flow for providing a customized service depending on a location of a mobile communication terminal in a mobile communication system according to an exemplary embodiment of the present invention; and

FIG. 6 is a schematic diagram illustrating an example of receiving a customized service depending on a location of a mobile communication terminal in a mobile communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions or constructions are omitted for clarity and conciseness.

The following description is a method and apparatus for providing a mobile communication terminal with a specific service depending on a location of the mobile communication terminal, using location-based service information that is stored in a Subscriber Identification Mobile (SIM) card according to the present invention. In the present invention, the SIM card includes a Universal SIM (USIM) card.

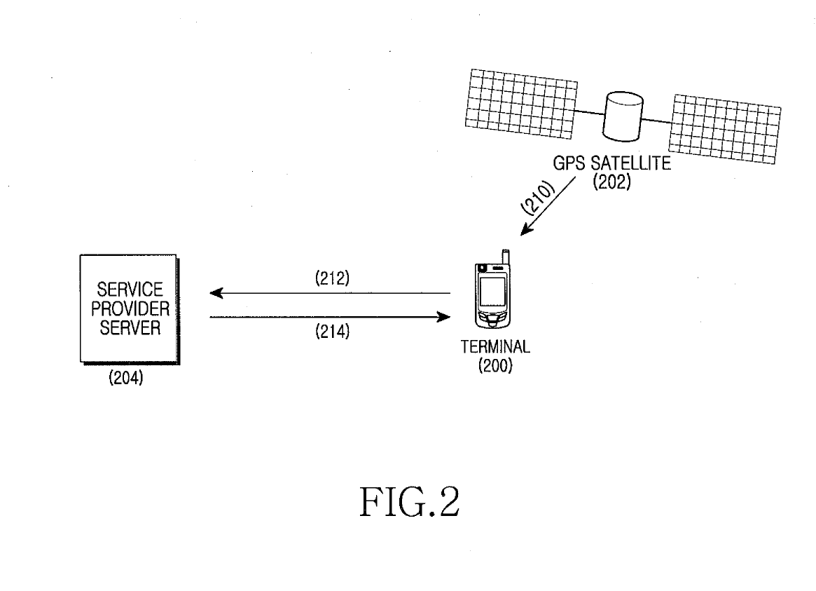

FIG. 2 is a diagram illustrating a construction of a system for providing a customized service depending on a location of a mobile communication terminal according to an exemplary embodiment of the present invention.

Referring to FIG. 2, the terminal 200 identifies customized service area information (or local coordinate) or operation information of a service depending on each area from a SIM card that is inserted into the terminal 200 to provide a customized service by location. Then, in step 210, the terminal 200 acquires its own current location information from a Global Positioning System (GPS) satellite 202. Then, the terminal 200 determines whether its own current location corresponds to a customized service area through a comparison between the customized service area information identified from the SIM card and its own current location information.

If the terminal 200 determines that its own current location corresponds to the customized service area, the terminal 200 identifies operation information corresponding to the customized service area in which the terminal 200 itself is located and then, transmits the operation information to a service provider server 204 using a Short Message Service (SMS) in step 212.

Upon receiving the operation information, the service provider server 204 provides a customized service corresponding to the received operation information to the terminal 200 in step 214. The service provider server 204 stores services mapped to the operation information in a database form.

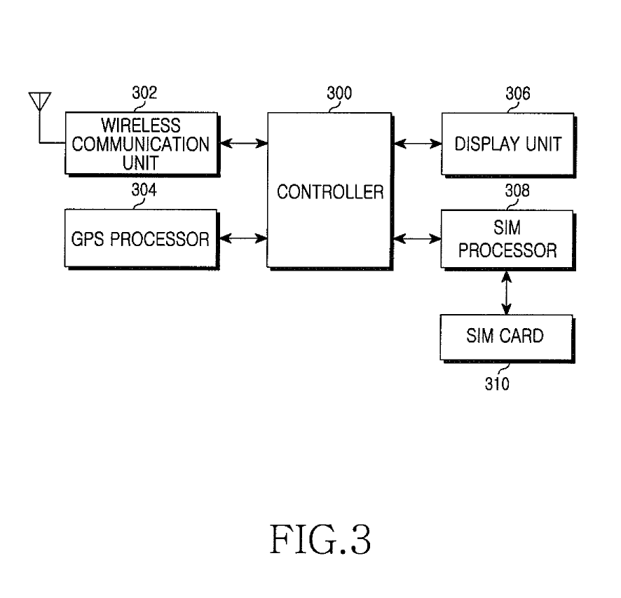

FIG. 3 is a block diagram illustrating a construction of a mobile communication terminal according to an exemplary embodiment of the present invention. The mobile communication terminal includes a controller 300, a wireless communication unit 302, a GPS processor 304, a display unit 306, a SIM processor 308, and a SIM card 310.

Referring to FIG. 3, the controller (that is, a Micro-Processor Unit (MPU)) 300 performs a general operation of the mobile communication terminal, for example, a process and control for a voice call and data communication. The controller 300 performs a control and process for providing a customized service suitable to a corresponding location according to a location change of the mobile communication terminal according to an exemplary embodiment of the present invention. That is, the controller 300 receives customized service area information (or local coordinate), which is stored in the SIM card 310, from the SIM processor 308 and forwards the received customized service area information to the GPS processor 304. The controller 300 receives specific customized service area information from the GPS processor 304 and provides the specific customized service area information to the SIM processor 308. Upon receiving a request for transmitting a short message including specific operation information from the SIM processor 308, the controller 300 generates and provides the short message including the operation information to the wireless communication unit 302 and processes and controls a customized service signal provided from the wireless communication unit 302.

The wireless communication unit 302, a module for connection with a network, processes a signal transmitted/received through an antenna. More particularly, the wireless communication unit 302 receives a short message including the operation information from the controller 300 and provides the received short message to a service provider server according to an exemplary embodiment of the present invention. The wireless communication unit 302 receives a customized service signal corresponding to the operation information from the service provider server and provides the customized service signal to the controller 300.

The GPS processor 304 including a GPS receiver receives a radio wave from a GPS satellite and identifies current location information of the mobile communication terminal through the received radio wave. The GPS processor 304 receives customized service area information stored in the SIM card 310 from the controller 300 and stores the received customized service area information. The GPS processor 304 determines whether the mobile communication terminal moves into a customized service area by continuously identifying current location information of the mobile communication terminal. If the mobile communication terminal moves into the customized service area, the GPS processor 304 provides corresponding area information to the controller 300.

The display unit 306 displays state information, numerals, characters, a large quantity of moving pictures and still pictures, etc. generated during operation of the mobile communication terminal. More particularly, the display unit 306 displays a variety of types of information (e.g., text, snapshot, and moving picture files) provided from the service provider server under the control of the controller 300 according to an exemplary embodiment of the present invention.

The SIM processor 308 is a module for managing and processing a variety of types of information that are stored in the SIM card 310. If the mobile communication terminal is powered on, the SIM processor 308 receives customized service area information (or local coordinate) and operation information mapped to each customized service area information from the SIM card 310 and provides the received customized service area information to the GPS processor 304. When receiving specific area information from the GPS processor 304, the SIM processor 308 identifies operation information mapped to the area information and provides the identified operation information to the SIM card 310. Then, when receiving a request for transmitting a short message including specific operation information from the SIM card 310, the SIM processor 308 forwards the short message to the controller 300.

The SIM card 310 can be mounted or released from the mobile communication terminal. The SIM card 310 has its own microprocessor and memory chips and stores a variety of types of user information. More particularly, the SIM card 310 stores a file that includes area information for a customized service area suitable to a location and operation information of a service provided in each area according to an exemplary embodiment of the present invention. If the mobile communication terminal is powered on, the SIM card 310 provides the SIM processor 308 with the customized service area information and the operation information each corresponding to the customized service area information. When receiving operation information corresponding to specific customized service area information from the controller 300, the SIM card 310 sends a request for generating and transmitting a short message including the operation information to the service provider server, to the SIM processor 308. The SIM card 310 performs data communication with the mobile communication terminal through a SIM Application Toolkit (SAT). The SAT refers to a series of commands and processes for enabling a network manager to provide its own service to the mobile communication terminal. In the description of an exemplary embodiment of the present invention, the SAT refers to a data communication between the mobile communication terminal and the SIM card.

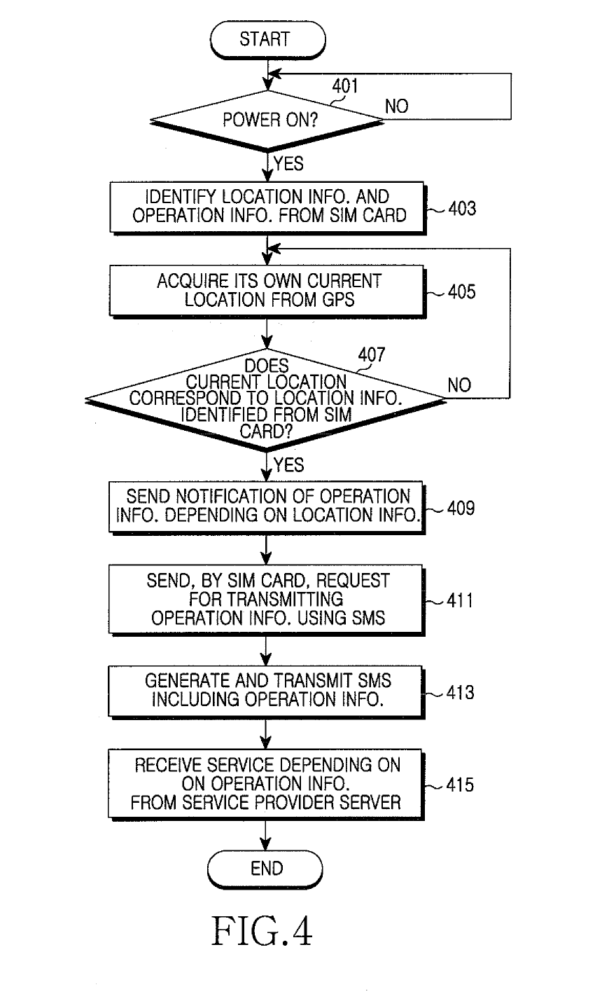

FIG. 4 is a flow diagram illustrating a process of a mobile communication terminal for providing a customized service depending on location according to an exemplary embodiment of the present invention.

Referring to FIG. 4, the terminal determines whether it is powered on in step 401. After being powered on, the terminal identifies customized service area information and operation information of a service depending on each area from the SIM card 310 that is mounted in the terminal in step 403. Otherwise, the terminal repeatedly performs the step 401. In step 405, the terminal acquires its own current location information through a radio wave received from a GPS satellite.

Then, in step 407, the terminal determines whether the mobile communication terminal moves into a location corresponding to the customized service area information through a comparison between the acquired current location information and the customized service area information identified from the SIM card 310.

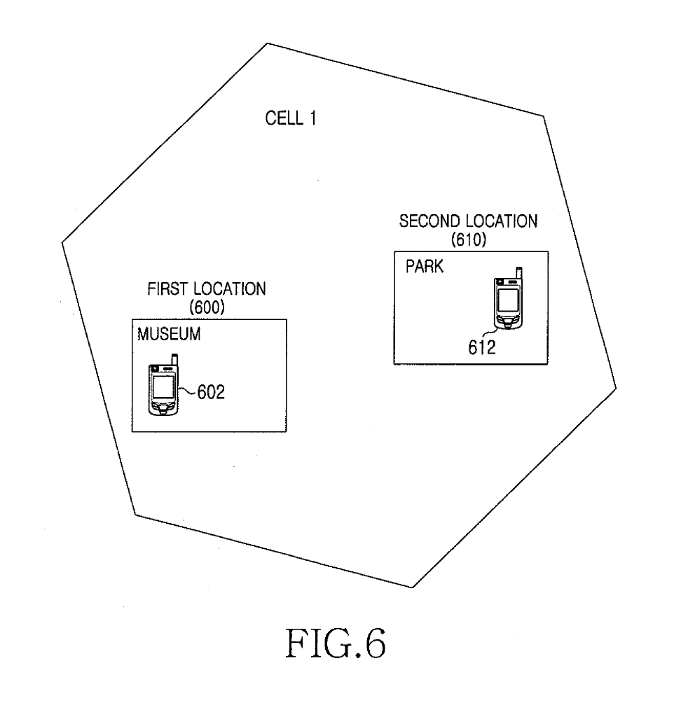

As an exemplary implementation, when a SIM card which is mounted in a terminal has a record of location information on a first location 600 and a second location 610 and operation information on the first location 600 and the second location 610 as shown in FIG. 6, the terminal determines where it is located, either in the first location 600 or the second location 610.

If the mobile communication terminal does not move into the location corresponding to the customized service area information in the step 407, the process returns to the step 405 and acquires current location information through a radio wave received from the GPS satellite.

If the mobile communication terminal moves into the location corresponding to the customized service area information in the step 407, the terminal sends a notification of operation information corresponding to information on an area where the terminal is currently located, to the SIM card 310 in step 409. Then, the terminal receives a request for transmitting a short message including the operation information to a service provider server, from the SIM card 310 in step 411, and generates and transmits the short message including the operation information to the service provider server in step 413.

Then, in step 415, the terminal receives a customized service corresponding to the operation information from the service provider server, processes the received customized service according to a service type, and provides the customized service to a user.

As an exemplary implementation, when a SIM card of a terminal has a record of location information on a first location 600 and a second location 610 and operation information on the first location 600 and the second location 610 as shown in FIG. 6, when the terminal moves into a museum that is the first location 600, the terminal may be provided with museum information (e.g., museum name, history, event, simple introductory moving picture, peripheral sight, etc.) from a service provider server, by providing the operation information on the first location 600 to the service provider server.

Then, the terminal terminates the process of an exemplary embodiment of the present invention.

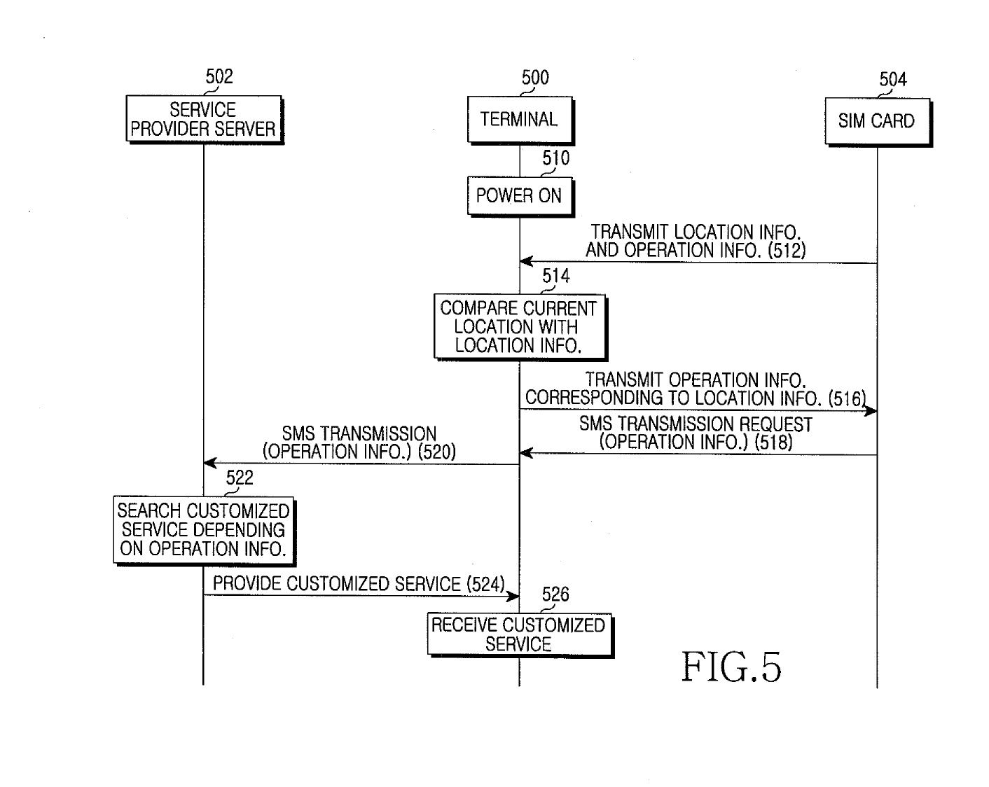

FIG. 5 is a ladder diagram illustrating a signal flow for providing a customized service depending on a location of a mobile communication terminal in a mobile communication system according to an exemplary embodiment of the present invention.

Referring to FIG. 5, if the terminal 500 is powered on in step 510, a SIM card 504 transmits customized service area information and operation information of a service depending on each area, to the terminal 500 using a SAT in step 512.

Then, in step 514, the terminal 500 determines whether the terminal 500 is located in a location corresponding to the customized service area information through a comparison between the customized service area information received from the SIM card 504 and its own current location information identified through a radio wave received from a GPS satellite.

If the terminal 500 is located in the location corresponding to the customized service area information, the terminal 500 transmits operation information corresponding to the customized service area information to the SIM card 504 using the SAT in step 516. If the terminal 500 is not located in the location corresponding to the customized service area information, the terminal 500 repeats the step 514.

Then, the SIM card 504 sends a request for generating and transmitting a short message including the operation information to a service provider server 502, to the terminal 500 in step 518. In response to the request, the terminal 500 generates and transmits the short message including the operation information to the service provider server 502 in step 520.

Then, the service provider server 502 searches a customized service corresponding to the operation information by identifying the operation information in the short message received from the terminal 500 in step 522. Then, the service provider server 502 provides the searched customized service to the terminal 500 in step 524.

Then, the terminal 500 receives the customized service corresponding to the operation information from the service provider server 502, processes the received customized service according to a service type, provides the customized service to a user in step 526, and then terminates the process of an exemplary embodiment of the present invention.

As in the above descriptions, the SIM card stores customized service area information and operation information of a service provided in each area and the terminal transmits the operation information to the service provider server. Unlike this, it may be also configured that after the SIM card stores only area information and the terminal transmits only the area information to the service provider server, the service provider server searches a service on the basis of the area information and provides the searched service to the terminal.

As described above, exemplary embodiments of the present invention have an effect of being able to provide a customized service taking into consideration users' exact locations and satisfying their desires, by providing a specific service depending on a location of a mobile communication terminal using location-based service information that is stored in a SIM card of the mobile communication terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing a service using location information in a mobile communication terminal, the method comprising:
identifying service area information and operation information allocated to each service area information from a Subscriber Identification Mobile (SIM) card;
transmitting the operation information, which is allocated to the service area information representing a current location of the terminal, to a service provider server; and
receiving a service corresponding to the operation information from the service provider server.

2. The method of claim 1, further comprising:
determining whether the terminal is located in a location corresponding to the service area information; and
if the terminal is located in the location corresponding to the service area information, transmitting the operation information to the service provider server.

3. The method of claim 2, wherein the determining of whether the terminal is located in the location corresponding to the service area information comprises:
identifying current location information on the terminal through a radio wave received from a Global Positioning System (GPS) satellite; and
comparing the current location information on the terminal with the service area information identified from the SIM card.

4. The method of claim 1, wherein the transmitting of the operation information comprises transmitting the operation information to the service provider server using a Short Message Service (SMS).

5. The method of claim 1, wherein the receiving of the service comprises receiving the service, which is searched and provided by the service provider server.

6. The method of claim 1, further comprising:
identifying its own current location information through a radio wave transmitted from a Global Positioning System (GPS) satellite; and
determining whether the terminal is located in a location corresponding to area information from the SIM card through a comparison between the current location information and the area information.

7. A method for providing a service using location information in a service provider server, the method comprising:
receiving operation information corresponding to a current location of a terminal, from the terminal;
searching for a service corresponding to the received operation information and
providing the searched service to the terminal according to results of the search.

8. The method of claim 7, wherein the operation information is transmitted to the service provider server using a Short Message Service (SMS) after the receiving of the operation information.

9. An apparatus for providing a service using location information in a mobile communication terminal, the apparatus comprising:
a Subscriber Identification Mobile (SIM) card for storing area information for provision of a service suitable to a location and operation information of a service provided in each area;
a SIM processor for identifying the area information and the operation information from the SIM card; and
a controller for controlling a transmission of operation information allocated to area information representing a current location of the terminal to a service provider server and for processing a service received from the service provider server.

10. The apparatus of claim 9, further comprising a Global Positioning System (GPS) processor for determining whether the terminal is located in a location corresponding to the area information identified from the SIM card, by identifying current location information on the terminal through a radio wave received from a GPS satellite.

11. The apparatus of claim 10, wherein the controller generates and transmits a short message including the operation information to the service provider server when the terminal is located in the location corresponding to the area information.

12. An apparatus for providing a service using location information in a mobile terminal, the apparatus comprising:
means for identifying service area information and operation information allocated to each service area information from a Subscriber Identification Mobile (SIM) card;
means for transmitting the operation information, which is allocated to the service area information representing a current location of the terminal, to a service provider server; and
means for receiving a service corresponding to the operation information from the service provider server.

13. The apparatus of claim 12, wherein the terminal can be determined whether it is located in a location corresponding to the service area information and, if the terminal is located in the location corresponding to the service area information, it transmits the operation information to the service provider server.

14. The apparatus of claim 13, wherein the terminal identifies current location information through a radio wave received from a Global Positioning System (GPS) satellite; and compares the current location information on the terminal with the service area information identified from the SIM card.

15. The apparatus of claim 12, wherein the terminal transmits the operation information to the service provider server using a Short Message Service (SMS).
